(19) United States
(12) Patent Application Publication
(10) Pub. No.: US 2005/0236819 A1
(43) Pub. Date: Oct. 27, 2005

(54) Safety device

(75) Inventors: Andreas Riedel, Illertissen (DE); Benedikt Heudorfer, Nersingen (DE); Christian Weyrich, Neu-Ulm (DE); Hans-Peter Sendelbach, Senden (DE); Jochen Maidel, Ulm (DE)

Correspondence Address: FOLEY AND LARDNER;SUITE 500, 3000 K STREET NW, WASHINGTON, DC, 20007, US

(73) Assignee: TAKATA-PETRI (Ulm) GmbH

(21) Appl. No.: 11/111,966

(22) Filed: Apr. 22, 2005

(30) Foreign Application Priority Data
Apr. 22, 2004 (DE) 10 2004 020 643.0

(51) Int. Cl. B60R 21/16

(52) U.S. Cl. 280/730.2; 280/743.2

(57) ABSTRACT

A safety device for a motor vehicle, having an inflatable airbag which, to protect a vehicle occupant on a vehicle seat—in particular when an accident or a hazardous situation occurs—is inflated and deployed laterally next to the vehicle occupant, and having a supporting device which interacts with the airbag and prevents or at least reduces a lateral movement of the airbag when the vehicle occupant plunges into the airbag.

### BACKGROUND

The invention relates to a safety device for a motor vehicle. In particular, to a safety device including an inflatable airbag which is configured to inflate and deploy laterally next to the vehicle occupant.

A safety device is disclosed in U.S. Pat. No. 5,636,862 (incorporated by reference herein). The disclosed safety device is arranged between a vehicle outer wall, for example a vehicle door, of a vehicle and a vehicle seat on which the vehicle occupant to be protected is situated. In the event of an accident, an airbag of the safety device is inflated in such a manner that it is deployed between the vehicle occupant and the vehicle outer wall. As a result, the vehicle occupant is protected from striking against or coming into contact with the vehicle outer wall. A tensioning strap is arranged on the airbag as a supporting device. The tensioning strap secures the airbag laterally, so that a lateral movement of the airbag when the vehicle occupant plunges into the airbag is prevented or at least reduced.

German patent specification 42 07 253 C2 and German laid-open specification 199 04 071 A1 (both incorporated by reference herein) also disclose safety devices, in which an airbag is deployed between two seats of a seat bench in the event of an accident in order to prevent the vehicle occupants situated on the seat bench from colliding.

### SUMMARY OF THE INVENTION

According to an embodiment of the invention, provision for the airbag together with the supporting device to be arranged on the inside of the vehicle, i.e. on that side of the vehicle occupant which faces the inside of the vehicle or on that side of the vehicle seat which faces the inside of the vehicle. The vehicle seat may be an “individual seat” or a seat of a seat bench.

One substantial advantage of the safety device according to the invention is that, owing to the arrangement of the airbag on the inside of the vehicle, an interaction of the seat belt on the belt-buckle side with the vehicle occupant's abdomen region is prevented. Protection against injuries to the abdomen region due to the belt buckle or the seat belt is provided by the airbag arranged on the inside of the vehicle because a lateral movement of the vehicle occupant in the direction of the interior of the vehicle is prevented.

According to another embodiment of the present invention, vehicle occupants sitting next to each other may be prevented from colliding; in particular, a collision of the occupants' heads can be prevented.

Another potential advantage of an embodiment of the present invention, is to provide additional protection even if the vehicle occupant who is to be protected sits on the vehicle side facing away from the impact; this is because, in this case, the airbag which is deployed on the inside of the vehicle protects a vehicle occupant (sitting facing away from the impact) against colliding with a vehicle occupant sitting facing the impact or with intruding vehicle regions (for example the interior of the vehicle).

According to another embodiment of the present invention, the safety device may include a supporting device which prevents or at least reduces a lateral movement of the airbag. The supporting device prevents the airbag, when the vehicle occupant plunges into it, from buckling away or “giving way”, as a result of which the protective effect of the airbag could be reduced.

According to another particular embodiment of the present invention, provision is made for the airbag to be able to inflated to a pressure of at least 100 kPa, in particular of at least 150 kPa, in the event of an accident. Such a high internal pressure of the airbag reduces the risk that the airbag could buckle away under the action of the occupant's body mass and the protective effect of the airbag could be reduced. A safety device having an airbag pressure of at least 100 kPa also makes it possible to reliably restrain both the vehicle occupant's head and the vehicle occupant's entire body.

According to another embodiment of the present invention, the airbag is provided with an insulating layer or a coating which is less gas-permeable than the rest of the airbag in order to reduce the likelihood of inflation gas from unintentionally or prematurely leaving the airbag under a drop in pressure. The insulating layer or the coating of the airbag covering preferably includes silicone or a silicone compound, since silicone is a particularly gas-tight material and can easily be processed.

According to an exemplary embodiment of the present invention, the supporting device for fixing the airbag in its “protective position” can be formed, for example, by at least one tensioning strap which is connected at its one tensioning-strap end to the airbag and at its other tensioning-strap end to the vehicle seat. The tensioning-strap end which is connected to the airbag is preferably fitted in the region of that airbag covering section which is as far away as possible from the gas generator of the safety device. The further the fastening point of the tensioning strap to the airbag is from the fastening point of the airbag to the vehicle, the greater is the fixing effect of the tensioning strap. Accordingly, it is particularly advantageous if the tensioning-strap end which is connected to the airbag is fitted in the region of a front edge of the airbag.

In order to achieve a tensioning-strap tensioning force which is dependent on the severity of the accident, the tensioning strap is preferably arranged in such a manner that it is automatically tensioned or “retensioned” by the vehicle occupant plunging into the airbag. For this purpose, the tensioning strap may preferably extend in the region of the vehicle occupant's shoulder and/or back, so that the vehicle occupant acts on the tensioning strap when he plunges into the airbag. An automatic tensioning of tensioning straps by the vehicle occupant is not only possible in the case of safety devices, in which the airbag is arranged on the inside of the vehicle, but also in the case of safety devices such as those described at the beginning, in which the airbag is arranged on the outside of the vehicle—i.e. between the vehicle occupant and the vehicle outer wall.

According to yet another alternative embodiment of the present invention, the supporting device may comprise at least one supporting element which is arranged in the interior of the airbag or on the outside of the airbag and absorbs lateral forces when the vehicle occupant plunges into the airbag in the event of an accident. A supporting element of this type may be formed, for example, by a plate or the like.

According to embodiments of the invention, the supporting element can be brought into its working or protective position in the event of an accident in various ways. For example, it is conceivable to bring the supporting element into the protective or supporting position by folding, by rotating, by extension of a telescopic system, by pivoting or by a roller blind technique.

In order to reduce the likelihood that the vehicle occupant may come directly into contact with the supporting element and can be injured as a result, an embodiment of the present invention provides for the supporting element to be connected to the airbag layer of the airbag that faces away from the vehicle occupant. In the case of this arrangement of the supporting element, it is ensured that there is an “air cushion layer” between the supporting element and the vehicle occupant protecting the vehicle occupant from the supporting element.

Moreover, according to another embodiment of the invention, the safety device may be mounted on the seat or on the seat bench. The mounting ensures that the safety device—before an accident—is at the same time moved over the entire seat-adjusting region or the entire region of the backrest setting (in the event of being positioned in the seat back). As a result, an always optimum position of the safety device is ensured, so that a minimum airbag size suffices for an effective protection of the occupant.

In addition, an embodiment of the invention relates to a method for protecting a vehicle occupant in the event of an accident, in which an airbag is inflated and deployed laterally next to the vehicle occupant, the airbag being supported in such a manner that a lateral movement of the airbag when the vehicle occupant plunges into the airbag is prevented or at least reduced.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a first exemplary embodiment for a safety device having an airbag which is held in its “protective position” by tensioning straps, the airbag having a head region for protecting the head of the vehicle occupant who is to be protected.

FIG. 2 shows a second exemplary embodiment for a safety device having an airbag without a head region.

FIGS. 3 and 4 are top plan views showing the placing of the tensioning straps in the case of the exemplary embodiments according to FIGS. 1 and 2 with reference to a vehicle seat which is unoccupied and a vehicle seat which is occupied by a vehicle occupant.

FIG. 5 shows a third exemplary embodiment for a safety device according to the invention having a supporting element integrated in the airbag as the supporting device.

### DETAILED DESCRIPTION

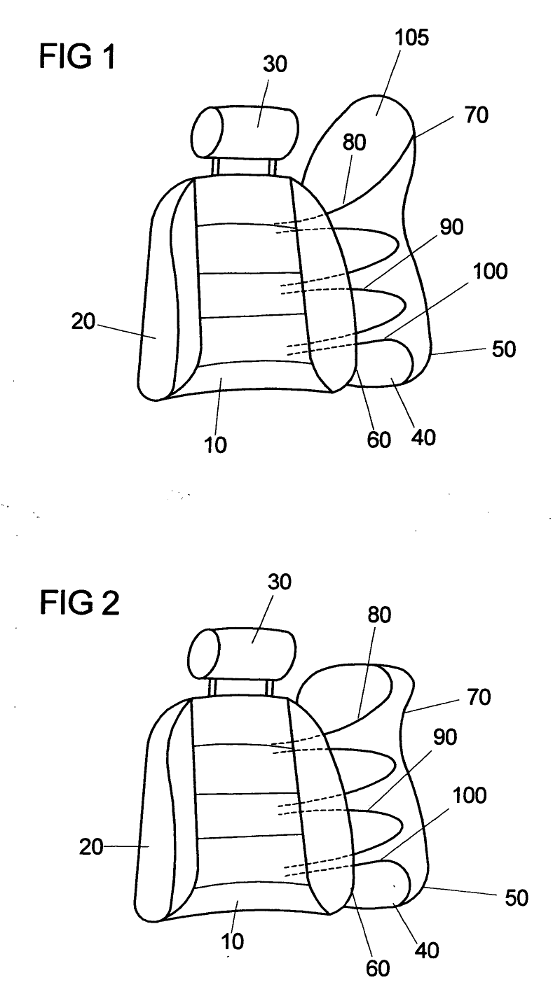

The same reference numbers are used in FIGS. 1 to 5 for identical or comparable components.

A vehicle seat 10 having a backrest 20 and a head restraint 30 can be seen in FIG. 1. The vehicle seat may be, for example, an individual seat or a seat of a seat bench. A safety device 40 is fitted at the side of the vehicle seat 10—on that side of the vehicle seat which faces the vehicle interior. The safety device 40 has an airbag 50 which, in the event of a vehicle accident or a hazardous situation (for example “pre-crash situation”), is inflated by a gas generator and deployed. In this case, the airbag 50 is positioned laterally next to the vehicle occupant on the inside of the vehicle.

The airbag 50 has a covering section 60 with which the airbag 50 is fastened in the region of the vehicle seat. The covering section 60 may therefore be referred to as the “fastening section”. A front edge 70 of the airbag 50 faces away from the covering section 60, which front edge, when the airbag is deployed, is arranged laterally next to the vehicle seat 10 and projects forwards in the direction of travel in relation to the backrest 20 (in the event of a vehicle seat oriented in the direction of travel).

Three tensioning straps 80, 90 and 100 are fitted to the front edge 70 of the airbag 50 and are connected to the vehicle seat 10. The tensioning straps 80, 90 and 100 laterally hold the airbag 50, which is deployed in the event of an accident, so that a vehicle occupant plunging into the airbag 50 cannot cause the airbag 50 to buckle or give way.

As can be seen in FIG. 1, the airbag 50 has a head section 105 which is positioned at head height in order to protect the head of the vehicle occupant to be protected.

FIG. 2 shows an exemplary embodiment for a safety device 40 having an airbag 50 without a head section; otherwise the airbag 50 according to FIG. 2 corresponds to the airbag 50 according to FIG. 1. It can be seen in FIG. 2 how the tensioning straps 80, 90 and 100 fix the position of the airbag 50.

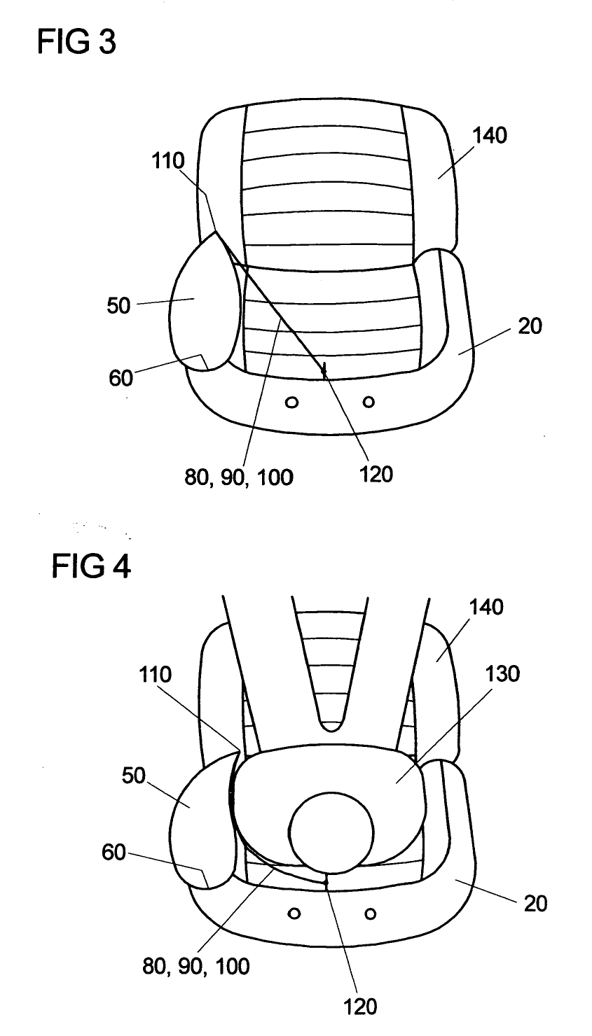

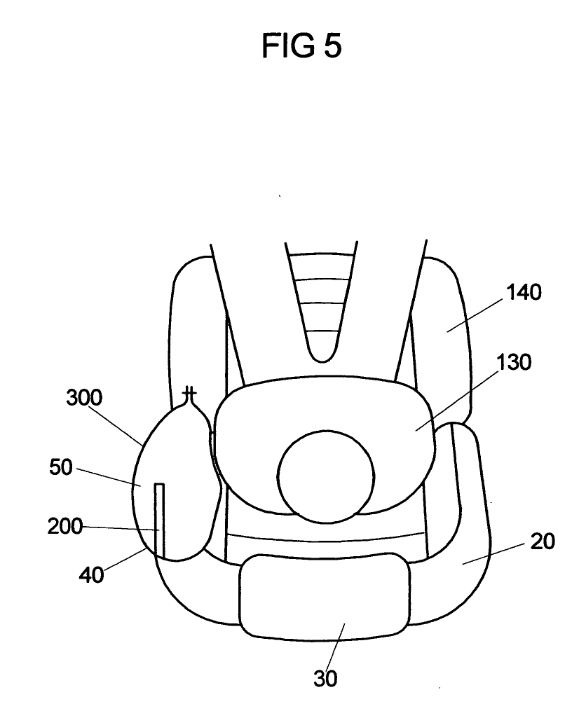

FIGS. 3 and 4 illustrate a plan view of the vehicle seat 10 having the safety device 40 according to FIG. 1 or FIG. 2. The three tensioning straps 80, 90 and 100 can be seen, which tensioning straps are connected in each case at their one tensioning-strap end 110 to the airbag 50 and at their other tensioning-strap end 120 to the vehicle seat 10, for example to the seat itself or the seat structure of the vehicle seat.

The position of the three tensioning straps 80, 90 and 100 when a vehicle occupant 130 is on a seat surface 140 of the vehicle seat 10 can be seen in FIG. 4. It can be seen that the vehicle occupant 130 presses on the tensioning straps 80, 90 and 100 as soon as he moves in the direction of the airbag 50. Owing to the pressing away of the tensioning straps 80, 90 and 100, the tensioning force of the tensioning straps is increased even more, so that the supporting effect of the tensioning straps on the airbag 50 is likewise increased even further.

The airbag 50 according to FIGS. 1 to 4 may be inflated at an internal pressure of the airbag of at least 100 kPa, preferably of at least 150 kPa, in order to ensure that the airbag is sufficiently stable and fixed and a yielding of the airbag or a buckling away of the airbag is prevented.

FIG. 5 discloses another embodiment of a safety device 40. The supporting effect of the airbag 50 is achieved by a supporting element 200 which is arranged in the interior of the airbag 50. The supporting element 200 is designed in such a manner that, in the activated state, it can absorb lateral forces and, in the event of a side impact, can limit a movement of the airbag 50 in the impact direction. The supporting element 200 is preferably connected to the airbag layer 300 of the airbag 50 that faces away from the occupant, so that a protective air cushion can be formed in the airbag 50 between the supporting element 200 and the vehicle occupant 130.

The supporting element 200 can be pivoted into its “protective position” shown in FIG. 5 by folding, rotating, pivoting, extension of a telescopic system or by a roller blind technique.

For the sake of clarity, FIG. 5 only shows a single supporting element 200. However, the safety device may additionally have further supporting elements in order to increase the supporting effect on the airbag 50.

According to other embodiments, the tensioning straps 80, 90 and 100 explained in conjunction with FIGS. 1 and 4 may also be used in combination with the supporting element 200 explained in conjunction with FIG. 5.

A common feature of the three exemplary embodiments explained in conjunction with FIGS. 1 to 5 is that the vehicle occupant 130 is fixed in his seat region by the airbag 50. As a result, the occupant cannot come into contact with intruding vehicle parts, with the interior of the vehicle or with other vehicle occupants. In addition, abdomen injuries due to the seat belt (not illustrated in FIGS. 1 to 5 for the sake of clarity) cutting into “soft parts” of the vehicle occupant are prevented if the latter is moved in the event of an accident in the direction of the belt buckle of the seat belt.

The mounting (shown in the figures) of the safety device 40 in a manner fixed on the seat ensures that the said safety device moves at the same time over the entire seat-adjusting region and the entire backrest-setting region; the effect achieved by this is that the airbag 50 always takes up the optimum position relative to the vehicle occupant. The airbag size and therefore the covering region of the airbag can therefore be selected to be very small.

The priority application, German Patent Application No. 10 2004 020643.0 filed on Apr. 22, 2004 is incorporated by reference herein in its entirety.

1. A safety device for a motor vehicle, comprising:
an inflatable airbag configured to inflate when an accident or hazardous situation occurs for protecting a vehicle occupant on a vehicle seat; wherein the airbag is positioned and configured to deploy laterally next to the vehicle occupant on the side of the vehicle occupant which faces the inside of the vehicle; and
a supporting device configured to interact with the airbag in order to reduce lateral movement of the airbag when the vehicle occupant plunges into the airbag.

2. The safety device of claim 1, wherein the device is configured so that the airbag inflates to a pressure of at least 100 kPa in the event of an accident.

3. The safety device of claim 1, wherein the airbag includes a covering material and an additional insulating layer which is situated in or on the airbag covering material and is less gas-permeable than the airbag covering material.

4. The safety device of claim 3, wherein the insulating layer is formed by a coating applied to the airbag covering material.

5. The safety device of claim 3, wherein the insulating layer comprises silicone or a silicone compound.

6. The safety device of claim 1, wherein the supporting device includes at least one tensioning strap which is connected at one end to the airbag and at the other end to the vehicle seat.

7. The safety device of claim 6, wherein the one end of the strap is connected to the airbag at a location which is spaced apart from a location where the airbag is connected to the vehicle seat.

8. The safety device of claim 7, wherein the one end of the strap is connected to a front edge of the airbag.

9. The safety device of claim 6, wherein the at least one tensioning strap is arranged in such a manner that it is tensioned by the vehicle occupant plunging into the airbag.

10. The safety device of claim 9, wherein the at least one tensioning strap is positioned to extend in the region of the vehicle occupant's shoulder and/or back.

11. The safety device of claim 1, wherein the supporting device comprises at least one supporting element which is arranged in the interior of the airbag or on the outside of the airbag and absorbs lateral forces when the vehicle occupant plunges into the airbag.

12. The safety device of claim 11, wherein the supporting element is brought into its working position in the event of an accident by folding, by rotating, by extension of a telescopic system, by pivoting or by a roller blind technique.

13. The safety device of claim 11, wherein the supporting element is connected to a layer of the airbag that faces away from the vehicle occupant.

14. The safety device of claim 1, wherein the safety device is mounted exclusively on the vehicle seat.

15. A method for protecting a vehicle occupant, in which an airbag is inflated and deployed laterally next to the vehicle occupant, the airbag being supported in such a manner that a lateral movement of the airbag when the vehicle occupant plunges into the airbag is prevented or at least reduced, wherein the airbag is deployed on the inside of the vehicle.

16. Method of claim 15, wherein the airbag is inflated to a pressure of at least 100 kPa in the event of an accident.

17. A safety device for a motor vehicle for protecting a vehicle occupant on a vehicle seat when an accident occurs, wherein the device includes an airbag configured to be inflated and deploy laterally next to the vehicle occupant, and a supporting device which interacts with the airbag and prevents or at least reduces a lateral movement of the airbag when the vehicle occupant plunges into the airbag, the supporting device having at least one tensioning strap which is connected at one tensioning-strap end to the airbag and at another tensioning-strap end to the vehicle seat, the at least one tensioning strap being arranged in such a manner that it is tensioned by the vehicle occupant plunging into the airbag.

18. The safety device of claim 17, wherein the at least one tensioning strap extends in the region of the vehicle occupant's shoulder and/or back.
